(19) United States
(12) Patent Application Publication
(10) Pub. No.: US 2013/0269857 A1
(43) Pub. Date: Oct. 17, 2013

(54) FLOOR SEAMING COMPOUND AND METHOD OF SEALING FLOORING SEAMS

(71) Applicants: Takashi Abe, Palos Verdes, CA (US); Hiroshi Kajiya, Fukuoka City (JP)

(72) Inventors: Takashi Abe, Palos Verdes, CA (US); Hiroshi Kajiya, Fukuoka City (JP)

(21) Appl. No.: 13/444,501

(22) Filed: Apr. 11, 2012

(51) Int. Cl. E04F 15/00; C09J 11/02

(52) U.S. Cl. 156/71; 106/287.35

(57) ABSTRACT

A composition for sealing flooring seams, including a water-based adhesive and a pigmented compound with a viscosity high enough that the composition may be applied vertically without significantly running and low enough that the composition will enter the opening of a seam gap. A method of sealing a seam between adjacent flooring sheets, including dispensing a sealing composition directly on the seam, waiting a sufficient time for the sealing composition to cure, and removing any excess sealing composition so that the filled seam is level with the flooring sheets.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Field of the Invention

The present invention relates to compositions for seaming flooring and methods of using such compositions. More particularly, the seaming compositions include a water-based flooring seam adhesive and a pigmented compound to provide a colored seaming compound.

2. Description of the Related Art

Resilient flooring, such as linoleum, vinyl, cork, and rubber, are typically affixed onto a sub-flooring using an adhesive. The resilient flooring may be in either sheet or tile form. However, a seam is formed at the abutment between the sheets or tiles. It is often desirable to seal this seam to avoid the obvious appearance and to avoid collecting dirt and moisture.

Although there are many methods and compounds for seaming flooring, these methods and compounds often are expensive, potentially dangerous, require expensive equipment, are labor intensive, and/or are not aesthetically attractive. For example, one method of seaming flooring uses a liquid seam sealer. Solvent based (e.g., tetrahydrofuran) liquid seam sealers have a thin viscosity. Due to this thin viscosity, liquid seam sealers will tend to run down into the seam or stay along the seam gap, and thus do not act as a filler, which decreases its effectiveness at adding to the structural integrity of the flooring and seams. In particular, it will not bridge gaps or openings. Accordingly, seaming with liquid seam sealers require installation by highly proficient workers capable of good seam cutting techniques to effectively seal the seam. Furthermore, due to the thin viscosity, liquid seam sealers are difficult to use on vertical applications, such as the seam of inside corners. Also, since the sealer sits on the seam line, it results in a shiny line of the seam, thereby becoming quite obvious. Furthermore, excess sealer on the seam cannot be removed and is instead left behind to be abraded by foot traffic. The use of solvent based seam sealers also has the detriment of being damaging to the surface of vinyl flooring if accidentally dropped on the flooring's surface, and is highly flammable.

Another method of seaming flooring is heat seam welding. This method uses a special heat welding gun and a heat welding rod. In this method, a “U” or V” shaped groove must be cut between the flooring sheets or tiles. Then the welding rod is fed through a welding tip attached to the electric heat-welding gun and the molten rod is applied into the grooved seam. The extra bulge of bead remaining over the surface of the seam can then be skived with a crescent knife after the rod has cooled to make the seaming joint level. Although this rod can be pigmented to match the flooring color, this process is expensive due to requiring specialized heat welding tools and labor intensive, requiring many steps to complete.

Yet another method is the use of a seam adhesive. In this method, adhesive is applied to the edge of one side of a flooring sheet or tile, and then tucked into place against another flooring edge to join the two pieces of flooring. Excess adhesive is then wiped off. This adhesive is initially white and turns translucent and can be difficult to apply, as the adhesive is applied to the side of cut edges.

Finally, flooring may be joined by the use of seam caulking. Although caulking is a filler, due to its high viscosity it does not appreciably enter the gap of the seam opening. Instead the caulk sits on the flooring seam where it may be worn out quickly by foot traffic. Thereby making this method less than practical.

### BRIEF SUMMARY

One embodiment of the present invention envisions a composition for sealing seams between resilient flooring. The composition includes both a water-based adhesive and a pigmented compound. Furthermore, the composition may have a viscosity that is high enough that the composition may be applied vertically without significantly running and low enough that the composition will enter the opening of a seam gap. The pigmented compound may be a water-based paint. In addition to, or in place of pigmented compound, the composition may include a photoluminescent pigment.

Another embodiment of the present invention envisions a method of sealing a seam between adjacent pieces of resilient flooring. This method includes the steps of dispensing a sealing composition directly on the seam, waiting a sufficient time for the sealing composition to cure, and removing any excess sealing composition so that the filled seam is level with the flooring. The sealing composition used in the method is made of a water-based adhesive and a pigmented compound, and has a viscosity low enough that the sealing composition will enter the seam but high enough that the sealing composition will fill the seam. The pigmented compound may be a water-based paint. In addition to, or in place of, the pigmented compound, the sealing composition may include a photoluminescent pigment.

The method may be utilized with resilient flooring in either sheet or tile form. Examples of which are cork, rubber, linoleum and/or vinyl. The flooring may be positioned such that the seam between flooring pieces is approximately 0.2-2.0 mm wide, in which case the sealing composition may be applied in a thickness of at least ⅔ the thickness of the flooring. For example, in the case of typical flooring having a thickness of 1.5 mm, the sealing composition may be applied in a thickness of approximately 1 mm. The sealing composition may be applied by squeezing an applicator bottle containing the sealing composition through an application tip directly into the seam. After the sealing composition has been applied, it is allowed to cure, preferably for between sixty minutes and six hours. After the sealing composition has cured, any excess sealing composition may be removed with a knife to make the seam level with the flooring.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view showing the application of a seaming composition into the seam of resilient flooring; and

FIG. 2 is a perspective view showing the removal of excess seaming composition from the resilient flooring seam.

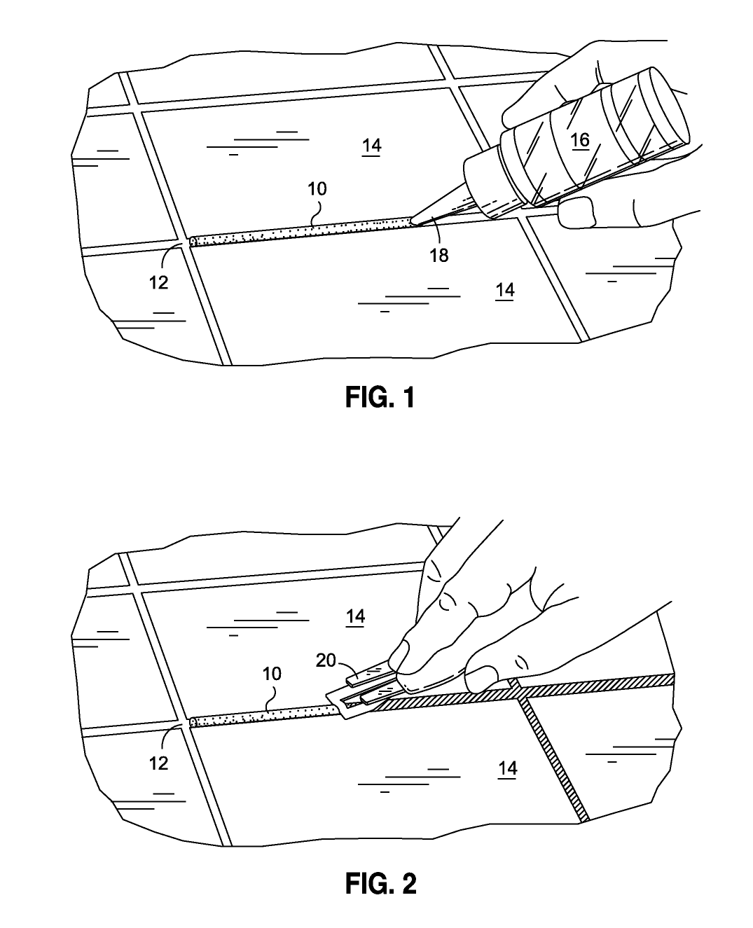

### DETAILED DESCRIPTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

One embodiment of the present disclosure is directed to a water-based (as opposed to traditional solvent-based systems) flooring seam adhesive that is mixed with a pigmented compound. By mixing the adhesive with the pigmented compound, one is able to achieve a color-matched seaming compound 10 capable of being applied in a single step. This is much different from the prior art, which results in a clear or translucent seam that does not match the color of the flooring.

The mixed compound 10 of this embodiment has an appropriate viscosity so that the compound 10 enters into the opening of a seam gap 12 and adheres to side edges of sheet flooring 14, with any excess remaining on top of the seam line. In particular, the composition 10 may have a viscosity that is high enough that the composition 10 may be applied vertically without significantly running and low enough that the composition will enter the opening of a seam gap 12. One way of achieving this viscosity is by using a water-based paint as the pigmented compound. In addition to, or in place of the pigmented compound, the seam adhesive 10 may contain a photoluminescent pigment so that the seam emits light.

Another embodiment of the present invention is directed to a method of applying the mixed compound 10 of the present invention in order to seal the seams 12 of resilient flooring 14. This method includes the steps of dispensing a sealing composition 10 directly on the seam 12, waiting a sufficient time for the sealing composition 10 to cure, and removing any excess sealing composition 10 so that the filled seam 12 is level with the flooring 14. The sealing composition 10 used in the method is made of a water-based adhesive and a pigmented compound, and has a viscosity low enough that the sealing composition 10 will enter the empty seam 12 but high enough that the sealing composition 10 will fill the empty seam 12. One example of the pigmented compound is a water-based paint colored to match the color of the flooring 14 on which it will be used. This is much simpler than many prior art methods in that grooves do not need to be made in the seams 12 to receive the compound 10, expensive heat welding equipment is not required, and the sealing composition 10 may be easily applied directly to the seam 12. Furthermore, since the sealing composition 10 has a particular viscosity capable of filling the empty seams 12, it is not necessary that the flooring materials 14 be perfectly abutted. Again, this simplifies installation of flooring, as a highly skilled installer is not required to cut and place the flooring 14.

The method may be utilized with resilient flooring 14 made of sheets or tiles of linoleum, vinyl, cork, laminate, wood, and/or rubber, or any other suitable flooring material known to those having ordinary skill in the art. The flooring 14 may be positioned such that the seam 12 between pieces of the flooring is approximately 0.2-2.0 mm wide, in which case the sealing composition 10 may be applied in a thickness of at least ⅔ the thickness of the flooring. For example, when used with typical flooring having a thickness of 1.5 mm, the composition 10 may be applied in a thickness of approximately 1 mm. The sealing composition 10 may be applied by squeezing an applicator bottle 16 containing the sealing composition 10 through an application tip 18 directly into the seam 12. Ideally, the sealing composition 10 is applied to a clean, dry seam 12 at room temperature. After the sealing composition 10 has been applied, it is allowed to cure, preferably for between sixty minutes and six hours. After the sealing composition 10 has cured, any excess sealing composition 10 may be removed with a knife 20 to make the seam 12 level with the flooring 14. The capability of easily removing the excess bead makes installation quicker and cleaner than prior methods. Any remaining residue 10 present on the surface of the flooring 14 may be removed with a damp cloth. As the composition 10 is not solvent-based, it will not damage the surface of the flooring 14.

As can be seen from the above description, the method of the present disclosure greatly improves on prior methods of sealing seams between flooring materials in that the seam is fully filled and sealed with an aesthetically pleasing color matched compound with a much easier and cheaper installation process. As opposed to heat sealing known in the prior art, the present method only requires the sealing compound 10 and a tool 20 for removing excess compound after it has cured. No electricity is needed for this method, less time is required for installation, and longevity and cleanliness of the seam is outstanding.

The above description is given by way of example, and not limitation. Given the above disclosure, one skilled in the art could devise variations that are within the scope and spirit of the invention disclosed herein, including various ways of applying the sealing composition to the seam, preparing the sealing composition, and types of flooring to utilize in the installation process. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A composition for sealing seams between flooring, said composition comprising a water-based adhesive and a pigmented compound.

2. The composition of claim 1, wherein the composition has a viscosity that is high enough that the composition may be applied vertically without significantly running and low enough that the composition will enter the opening of a seam gap.

3. The composition of claim 1, wherein the pigmented compound is a water-based paint.

4. The composition of claim 1 further comprising a photoluminescent pigment.

5. A method of sealing a seam between adjacent pieces of flooring comprising:
a. dispensing a sealing composition comprising a water-based adhesive and a pigmented compound directly on the seam, wherein the sealing composition has a viscosity low enough that the sealing composition will enter the seam but high enough that the sealing composition will fill the seam;
b. waiting a sufficient time for the sealing composition to cure; and
c. removing any excess sealing composition so that the filled seam is level with the flooring sheets.

6. The method of claim 5, wherein the flooring pieces are linoleum.

7. The method of claim 5, wherein the flooring pieces are vinyl.

8. The method of claim 5, wherein the flooring pieces are cork.

9. The method of claim 5, wherein the flooring pieces are rubber.

10. The method of claim 5, wherein the flooring pieces are wood.

11. The method of claim 5, wherein the flooring pieces are laminate.

12. The method of claim 5, wherein the pigmented compound is a water-based paint.

13. The method of claim 5, wherein the sealing composition further comprises a photoluminescent pigment.

14. The method of claim 5, wherein the seam is approximately 0.2-2.0 mm wide.

15. The method of claim 14, wherein the sealing composition is applied in a thickness of at least ⅔ the thickness of the flooring pieces.

16. The method of claim 15, wherein the sealing composition is applied in a thickness of approximately 1 mm.

17. The method of claim 5, wherein the sealing composition is applied in step a) by squeezing an applicator bottle containing the sealing composition through an application tip into the seam.

18. The method of claim 5, wherein in step b) the sealing composition is allowed to cure for at least 60 minutes.

19. The method of claim 5, wherein in step c) the excess sealing composition is removed with a knife.
